(19) United States
(12) Patent Application Publication
(10) Pub. No.: US 2024/0386852 A1
(43) Pub. Date: Nov. 21, 2024

(54) Systems and Methods for Achieving Consistent Front-of-Screen Performance for Varying Media Rates

(71) Applicant: Apple Inc., Cupertino, CA (US)

(72) Inventors: Daming Xu, Santa Clara, CA (US); Mingxia Gu, Campbell, CA (US); Mookyung Son, Cupertino, CA (US); Victor H Yin, Cupertino, CA (US); Wenzhong Liu, San Jose, CA (US); Sameer M Venugopal, Milpitas, CA (US); Jun Qi, San Jose, CA (US)

(21) Appl. No.: 18/618,592

(22) Filed: Mar. 27, 2024

Related U.S. Application Data
(60) Provisional application No. 63/466,540, filed on May 15, 2023.

(51) Int. Cl. G09G 3/3258; G09G 3/3233

(52) U.S. Cl. CPC G09G 3/3258; G09G 3/3233; G09G 2310/027; G09G 2320/0693

(57) ABSTRACT

Front-of-screen performance of the electronic display may be highly sensitive to timing settings of emission and anode reset frequencies. Changes in the timing settings may result in diverging brightness and color performance on the electronic display, which may negatively impact user experience. In some cases, emission frequency of the self-emissive display pixels may be fixed at a value, such as 120 Hertz (Hz), 240 Hz, or 480 Hz. The anode reset frequency may be set at a divisor of the emission frequency. Some refresh rates may be divisors of the pixel emission frequency. However, other refresh rates may not be divisors of the pixel emission frequency. For such non-divisor refresh rates, different driving schemes may be used to compensate for a difference from the pixel emission frequency.

### CROSS-REFERENCE TO RELATED APPLICATIONS

This application claims priority to U.S. Provisional Application No. 63/466,540, filed May 15, 2023, entitled “Systems and Methods for Achieving Consistent Front-of-Screen Performance for Varying Media Rates,” the disclosure of which is incorporated by reference herein in its entirety for all purposes.

### SUMMARY

This disclosure relates to methods for improving front-of-screen consistency between various refresh rates.

A summary of certain embodiments disclosed herein is set forth below. It should be understood that these aspects are presented to provide the reader with a brief summary of these certain embodiments and that these aspects are not intended to limit the scope of this disclosure.

Electronic displays may be found in numerous electronic devices, from mobile phones to computers, televisions, automobile dashboards, and augmented reality or virtual reality glasses, to name just a few. Electronic displays with self-emissive display pixels produce their own light. Self-emissive display pixels may include any suitable light-emissive elements, including light-emitting diodes (LEDs) such as organic light-emitting diodes (OLEDs) or micro-light-emitting diodes (uLEDs). By causing different display pixels to emit different amounts of light, individual display pixels of an electronic display may collectively produce images.

Front-of-screen (FoS) performance of an electronic display may be highly sensitive to timing settings of display pixel emission and anode reset frequencies. Changes in the timing settings may result in diverging brightness and color performance on the electronic display, which may negatively impact user experience. In some cases, emission frequency of the self-emissive display pixels may be fixed at a value, such as 120 Hertz (Hz), 240 Hz, or 480 Hz. The anode reset frequency may be fixed as a divisor of the emission frequency, such as 30 Hz, 60 Hz, or 120 Hz. Refresh rates, however, may be adjusted via user settings. Some refresh rates, such as 24 Hz, 30 Hz, 34.3 Hz, 80 Hz, and so on may be divisors of the pixel emission frequency. Other refresh rates, such as 50 Hz, 59.94 Hz, 47.95 Hz, and so on, may not be divisors of the pixel emission frequency. For such non-divisor refresh rates, different driving schemes may be used to compensate for a difference from the pixel emission frequency, as the different from the pixel emission frequency may negatively impact FoS performance. The different driving schemes may include applying different time constants to a pixel, using different lookup tables (LUTs) based on refresh rate, or adjusting an LUT based on refresh rate.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device having an electronic display, in accordance with an embodiment;

FIG. 2 is an example of the electronic device in the form of a handheld device, in accordance with an embodiment;

FIG. 3 is an example of the electronic device in the form of a tablet device, in accordance with an embodiment;

FIG. 4 is an example of the electronic device in the form of a notebook computer, in accordance with an embodiment;

FIG. 5 is an example of the electronic device in the form of a wearable device, in accordance with an embodiment;

FIG. 6 is a block diagram of the electronic display, in accordance with an embodiment;

FIG. 7 illustrates operation of a display pixel with an emission frequency of 480 Hz, an anode refresh frequency of 240 Hz, and a refresh rate of 50 Hz;

FIG. 8 illustrates operation of a display pixel under a high-brightness condition at various refresh rates;

FIG. 9 illustrates operation of a display pixel under a low-brightness condition at various refresh rates;

FIG. 10 includes a diagram illustrating the charging of a display pixel with a 60 Hz refresh rate and the charging of a display pixel with a 50 Hz refresh rate when the display pixels share an optical calibration lookup table (OC LUT) and a diagram illustrating the charging of a display pixel with a 60 Hz refresh rate and the charging of a display pixel with a 50 Hz refresh rate when the display pixels have separate OC LUTs, in accordance with an embodiment;

FIG. 11 is a flowchart of a method for adjusting the time constant of one or more of the display pixels to reduce or eliminate a brightness differential between at least two of the display pixels, in accordance with an embodiment;

FIG. 12 includes an OC LUT providing various pixel gamma (PGMA) voltages and digital gamma (DGMA) codes according to global display brightness (GDB) (e.g., display brightness value (DBV)) bands;

FIG. 13 is a flowchart of a method for selecting a set of OC LUTs based on a determined refresh rate to reduce or eliminate a brightness differential between at least two display pixels, in accordance with an embodiment;

FIG. 14 is a plot illustrating conditions under which display pixels may share a common OC LUT and conditions under which display pixels may utilize separate OC LUTs, in accordance with an embodiment; and

FIG. 15 is a block diagram illustrating the physical topology of the processes discussed above, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Front-of-screen (FoS) performance of the electronic display may be highly sensitive to timing settings of emission frequencies and anode reset frequencies of an electronic display. Changes in the timing settings may result in diverging brightness and color performance on the electronic display, which may negatively impact user experience. In some cases, emission frequency of the self-emissive display pixels may be fixed at a value, such as 120 Hertz (Hz), 240 Hz, or 480 Hz. The anode reset frequency may be fixed at a divisor of the emission frequency, such as 30 Hz, 60 Hz, or 120 Hz. However, refresh rates may be changed and adjusted via user settings. Some refresh rates may be divisors of the pixel emission frequency, such as 24 Hz, 30 Hz, 34.3 Hz, 80 Hz, and so on. Other refresh rates may not be divisors of the pixel emission frequency, such as 50 Hz, 59.94 Hz, 47.95 Hz, and so on. For such non-divisor refresh rates, different driving schemes may be used to compensate for a difference between various refresh rates and the pixel emission frequency, as the different from the pixel emission frequency may negatively impact FoS performance.

Embodiments herein provide various apparatuses and techniques to maintain consistent brightness and color between varying refresh rates. In an embodiment, multiple optical calibration (OC) lookup tables (LUTs) may be used for corresponding gamma bands. For refresh rates with longer emission pulse widths (e.g., a 50 Hz refresh rate), a driving voltage may be reduced in order to achieve a similar or identical integrated brightness with respect to refresh rates having shorter emission pulse widths. That is, the driving voltage may be adjusted such that a charging speed of a display pixel 54 having a refresh rate with longer emission pulse width may be slower than a charging speed of a display pixel 54 having refresh rate with shorter emission pulse width. Slowing down the charging speed of the display pixels 54 having refresh rates with longer emission pulse widths may cause the electronic display to behave similarly with a lower refresh rate (e.g., 50 Hz refresh rate) as it would with a higher refresh rate (e.g., 60 Hz refresh rate). This may be verified from measurements of panel dynamic response.

In another embodiment, a single OC LUT may be shared between various refresh rates, and separate LUTs may be used at the global display brightness (GDB) values (e.g., display brightness values (DBVs)) and/or gray levels where different refresh rates produce a brightness and/or color deviation or difference beyond a threshold. As used herein, the GDB and DBV refer to a global display brightness setting (e.g., a setting that corresponds to the maximum brightness level of the display), which may be selected by a person viewing the display and/or based on ambient light conditions. At certain lower GDB and/or gray levels, the different charging speeds of the pixels may cause the pixels to produce noticeably different amounts of light.

For example, a common OC LUT may be used for display pixels having a refresh rate of 50 Hz and display pixels having a refresh rate of 60 Hz under certain conditions (e.g., when the display pixels are associated with a given gray level or GDB value). However, different OC LUTs may be used for display pixels having a refresh rate of 50 Hz and display pixels having a refresh rate of 60 Hz under other conditions (e.g., when the display pixels are associated with an additional gray level or GDB value). While multiple OC LUTs are discussed, it should be noted that in some cases, there may be a single LUT that is calibrated for a first refresh rate (e.g., 60 Hz) but is adjusted via unity gain to be used for display pixels having a second refresh rate (50 Hz).

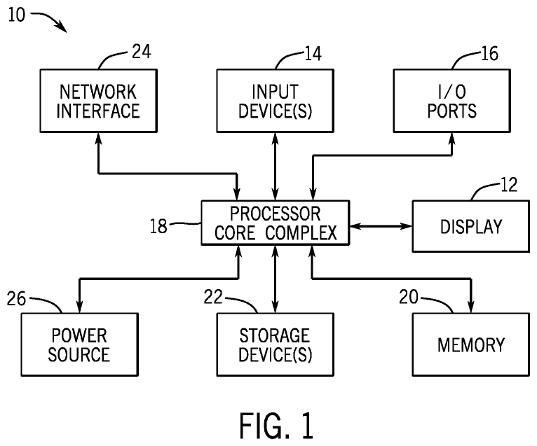

With this in mind, an example of an electronic device 10, which includes an electronic display 12 that may benefit from these features, is shown in FIG. 1. FIG. 1 is a schematic block diagram of the electronic device 10. The electronic device 10 may be any suitable electronic device, such as a computer, a mobile (e.g., portable) phone, a portable media device, a tablet device, a television, a handheld game platform, a personal data organizer, a virtual-reality headset, a mixed-reality headset, a wearable device, a watch, a vehicle dashboard, and/or the like. Thus, it should be noted that FIG. 1 is merely one example of a particular implementation and is intended to illustrate the types of components that may be present in an electronic device 10.

In addition to the electronic display 12, as depicted, the electronic device 10 includes one or more input devices 14, one or more input/output (I/O) ports 16, a processor core complex 18 having one or more processors or processor cores and/or image processing circuitry, memory 20, one or more storage devices 22, a network interface 24, and a power supply 26. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the memory 20 and the storage devices 22 may be included in a single component. Additionally or alternatively, image processing circuitry of the processor core complex 18 may be disposed as a separate module or may be disposed within the electronic display 12.

The processor core complex 18 is operably coupled with the memory 20 and the storage device 22. As such, the processor core complex 18 may execute instructions stored in memory 20 and/or a storage device 22 to perform operations, such as generating or processing image data. The processor core complex 18 may include one or more microprocessors, one or more application specific processors (ASICs), one or more field programmable logic arrays (FPGAs), or any combination thereof.

In addition to instructions, the memory 20 and/or the storage device 22 may store data, such as image data. Thus, the memory 20 and/or the storage device 22 may include one or more tangible, non-transitory, computer-readable media that store instructions executable by processing circuitry, such as the processor core complex 18, and/or data to be processed by the processing circuitry. For example, the memory 20 may include random access memory (RAM) and the storage device 22 may include read only memory (ROM), rewritable non-volatile memory, such as flash memory, hard drives, optical discs, and/or the like.

The network interface 24 may enable the electronic device 10 to communicate with a communication network and/or another electronic device 10. For example, the network interface 24 may connect the electronic device 10 to a personal area network (PAN), such as a Bluetooth network, a local area network (LAN), such as an 802.11x Wi-Fi network, and/or a wide area network (WAN), such as a fourth-generation wireless network (4G), LTE, or fifth-generation wireless network (5G), or the like. In other words, the network interface 24 may enable the electronic device 10 to transmit data (e.g., image data) to a communication network and/or receive data from the communication network.

The power supply 26 may provide electrical power to operate the processor core complex 18 and/or other components in the electronic device 10, for example, via one or more power supply rails. Thus, the power supply 26 may include any suitable source of electrical power, such as a rechargeable lithium polymer (Li-poly) battery and/or an alternating current (AC) power converter. A power management integrated circuit (PMIC) may control the provision and generation of electrical power to the various components of the electronic device 10.

The I/O ports 16 may enable the electronic device 10 to interface with another electronic device 10. For example, a portable storage device may be connected to an I/O port 16, thereby enabling the electronic device 10 to communicate data, such as image data, with the portable storage device.

The input devices 14 may enable a user to interact with the electronic device 10. For example, the input devices 14 may include one or more buttons, one or more keyboards, one or more mice, one or more trackpads, and/or the like. Additionally, the input devices 14 may include touch sensing components implemented in the electronic display 12, as described further herein. The touch sensing components may receive user inputs by detecting occurrence and/or position of an object contacting the display surface of the electronic display 12.

In addition to enabling user inputs, the electronic display 12 may provide visual representations of information by displaying one or more images (e.g., image frames or pictures). For example, the electronic display 12 may display a graphical user interface (GUI) of an operating system, an application interface, text, a still image, or video content. To facilitate displaying images, the electronic display 12 may include a display panel with one or more display pixels. The display pixels may represent sub-pixels that each control a brightness of one color component (e.g., red, green, or blue for a red-green-blue (RGB) pixel arrangement).

The electronic display 12 may display an image by controlling the brightness of its display pixels based at least in part image data associated with corresponding image pixels in image data. In some embodiments, the image data may be generated by an image source, such as the processor core complex 18, a graphics processing unit (GPU), an image sensor, and/or memory 20 or storage devices 22. Additionally, in some embodiments, image data may be received from another electronic device 10, for example, via the network interface 24 and/or an I/O port 16.

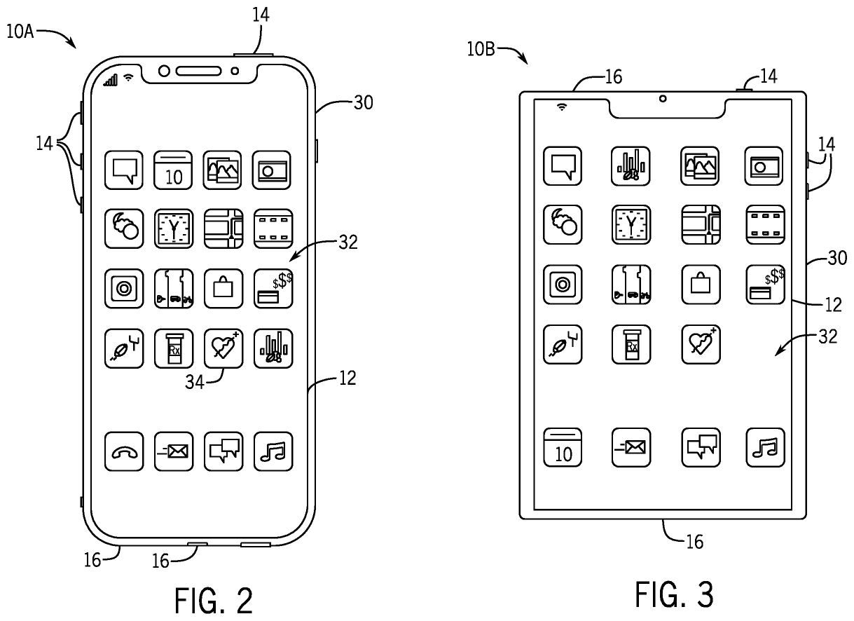

One example of the electronic device 10, specifically a handheld device 10A, is shown in FIG. 2. FIG. 2 is a front view of the handheld device 10A representing an example of the electronic device 10. The handheld device 10A may be a portable phone, a media player, a personal data organizer, a handheld game platform, and/or the like. For example, the handheld device 10A may be a smart phone, such as any iPhone® model available from Apple Inc.

The handheld device 10A includes an enclosure 30 (e.g., housing). The enclosure 30 may protect interior components from physical damage and/or shield them from electromagnetic interference. In the depicted embodiment, the electronic display 12 is displaying a graphical user interface (GUI) 32 having an array of icons 34. By way of example, when an icon 34 is selected either by an input device 14 or a touch sensing component of the electronic display 12, an application program may launch.

Input devices 14 may be provided through the enclosure 30. As described above, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. The I/O ports 16 also open through the enclosure 30. The I/O ports 16 may include, for example, a Lightning® or Universal Serial Bus (USB) port.

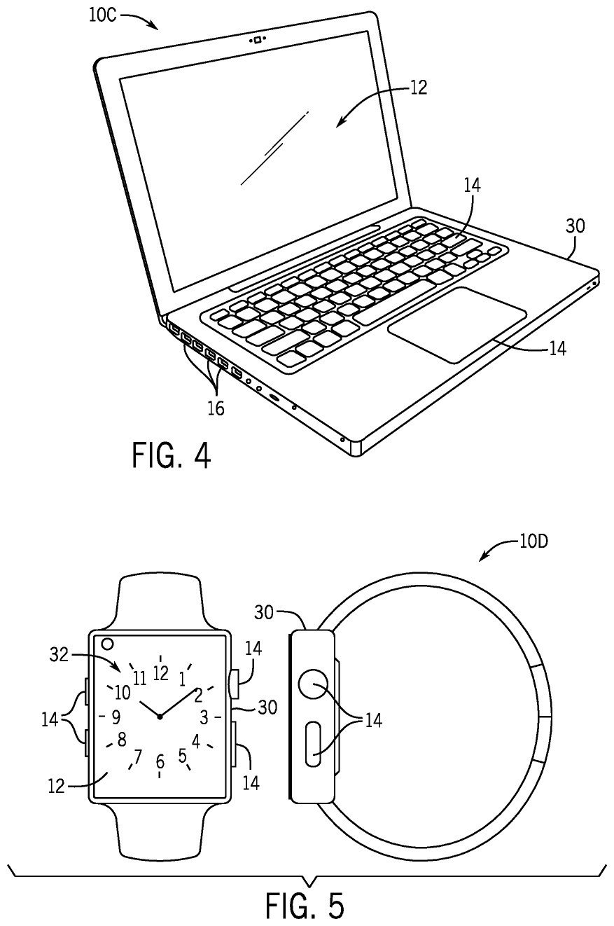

The electronic device 10 may take the form of a tablet device 10B, as shown in FIG. 3. FIG. 3 is a front view of the tablet device 10B representing an example of the electronic device 10. By way of example, the tablet device 10B may be any iPad® model available from Apple Inc. A further example of a suitable electronic device 10, specifically a computer 10C, is shown in FIG. 4. FIG. 4 is a front view of the computer 10C representing an example of the electronic device 10. By way of example, the computer 10C may be any MacBook® or iMac® model available from Apple Inc. Another example of a suitable electronic device 10, specifically a watch 10D, is shown in FIG. 5. FIG. 5 are front and side views of the watch 10D representing an example of the electronic device. By way of example, the watch 10D may be any Apple Watch® model available from Apple Inc. As depicted, the tablet device 10B, the computer 10C, and the watch 10D all include respective electronic displays 12, input devices 14, I/O ports 16, and enclosures 30.

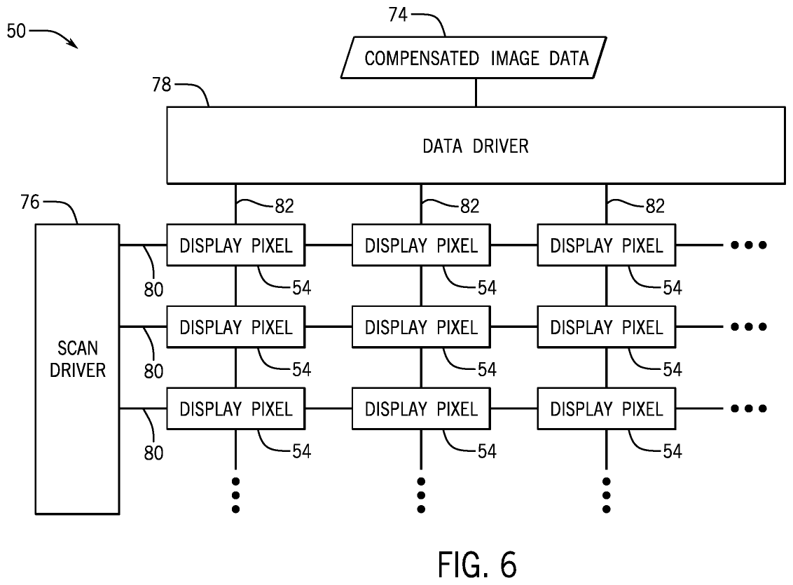

Describing now the display pixel array 50, FIG. 6 is a block diagram of the display pixel array 50 of the electronic display 12. It should be understood that, in an actual implementation, additional or fewer components may be included in the display pixel array 50.

The electronic display 12 may receive compensated image data 74 for presentation on the electronic display 12. The electronic display 12 includes display driver circuitry that includes scan driver circuitry 76 and data driver circuitry 78. The display driver circuitry controls programing the compensated image data 74 into the display pixels 54 for presentation of an image frame via light emitted according to each respective bit of compensated image data 74 programmed into one or more of the display pixels 54.

The display pixels 54 may each include one or more self-emissive elements, such as a light-emitting diodes (LEDs) (e.g., organic light emitting diodes (OLEDs) or micro-LEDs (uLEDs)), however other pixels may be used with the systems and methods described herein including but not limited to liquid-crystal devices (LCDs), digital mirror devices (DMD), or the like, and include use of displays that use different driving methods than those described herein, including partial image frame presentation modes, variable refresh rate modes, or the like.

Different display pixels 54 may emit different colors. For example, some of the display pixels 54 may emit red light, some may emit green light, and some may emit blue light. Thus, the display pixels 54 may be driven to emit light at different brightness levels to cause a user viewing the electronic display 12 to perceive an image formed from different colors of light. The display pixels 54 may also correspond to hue and/or brightness levels of a color to be emitted and/or to alternative color combinations, such as combinations that use red (R), green (G), blue (B), or others.

The scan driver circuitry 76 may provide scan signals (e.g., pixel reset, data enable, on-bias stress) on scan lines 80 to control the display pixels 54 by row. For example, the scan driver circuitry 76 may cause a row of the display pixels 54 to become enabled to receive a portion of the compensated image data 74 from data lines 82 from the data driver circuitry 78. In this way, an image frame of the compensated image data 74 may be programmed onto the display pixels 54 row by row. Other examples of the electronic display 12 may program the display pixels 54 in groups other than by row.

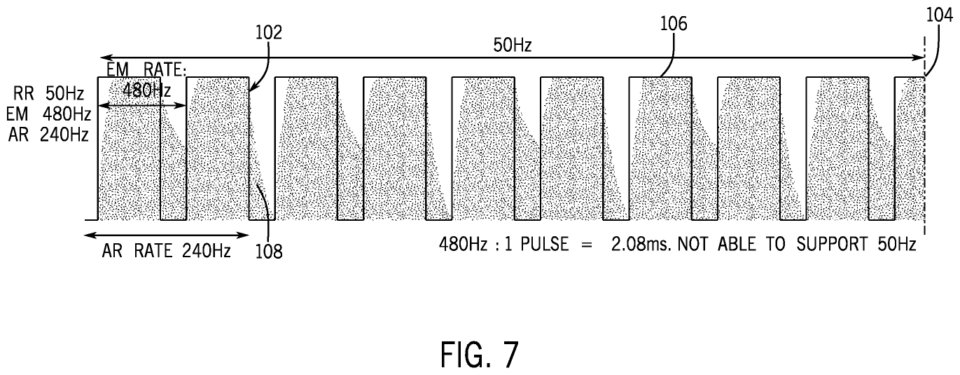

In some cases, emission frequency of the self-emissive display pixels may be fixed at a value, such as 120 Hertz (Hz), 240 Hz, or 480 Hz. The anode reset frequency may be set at a divisor of the emission frequency, such as 30 Hz, 60 Hz, or 120 Hz. Some refresh rates may be divisors of the pixel emission frequency, such as 24 Hz, 30 Hz, 34.3 Hz, 80 Hz, and so on. However, other refresh rates may not be divisors of the pixel emission frequency, and thus may not be supported by the display 12 with certain emission frequencies (e.g., 480 Hz). FIG. 7 illustrates operation of a display pixel 54 with an emission frequency of 480 Hz, an anode refresh frequency of 240 Hz, and a refresh rate of 50 Hz. As the anode refresh frequency is one-half of the emission frequency, an anode reset 102 may occur at every two pulses 106. A voltage 108 of the display pixel 54 (indicated by the shading in each of the pulses 106) may reach a maximum amplitude for each pulse 106, indicating full charging—and thus full brightness—of the display pixel 54. As 50 is not a divisor of 480, the pulse 104 undergoes only a partial refresh, which may lead to FoS issues and negatively impact user experience. For such non-divisor refresh rates, different driving schemes may be used to compensate for a difference between various refresh rates and the pixel emission frequency.

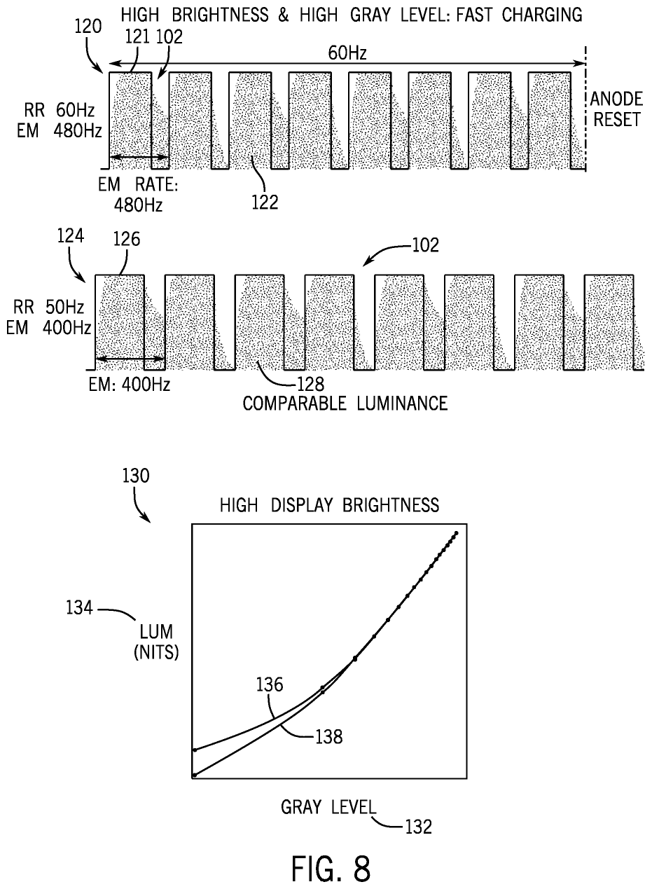

FIG. 8 illustrates operation of a display pixel 54 under high-brightness (e.g., high-luminance) condition at various refresh rates. Timing diagram 120 illustrates an image frame having a 480 Hz emission rate, a 60 Hz refresh rate, and an anode reset rate of 240 Hz. Similar to FIG. 7, the timing diagram 120 illustrates an emission rate of 480 Hz and an anode reset rate of 240 Hz, thus the anode reset 102 occurs every two pulses 121. The voltage 122 of the display pixel 54 (indicated by the shading in each of the pulses 121) may reach a maximum amplitude for each of the pulses 121, indicating full charging—and thus full brightness—of the display pixel 54.

Timing diagram 124 illustrates a display pixel 54 having a 50 Hz refresh rate. To avoid the FoS issues discussed with respect to FIG. 7, the emission frequency may be set such that the refresh rate is a divisor of the emission frequency. For example, as the refresh rate of the timing diagram 124 is 50 Hz, the emission frequency may be set to a multiple of 100 Hz, such as 400 Hz, and the anode refresh rate may be set to 200 Hz, such that an anode reset 102 occurs every two pulses 126. It may be appreciated that, as the refresh rate of the timing diagram is 50 Hz rather than 60 Hz (as show in the timing diagram 120), the pulses 126 may be 20% longer than the width of the pulses 121. Given the extended pulse width, the display pixels 54 may have more time to charge at each pulse 126 than at the pulses 121. However, at high brightness, the charging of the pulses 121 and 126 is sufficiently fast that all pulses 121 and 126 may be fully charged despite the differences in charging time. Indeed, voltage 128 of the display pixels 54 (indicated by the shading in each of the pulses 126) may reach a maximum amplitude for each of the pulses 126, indicating full charging—and thus full brightness—of the display pixel 54. While the emission frequency in the example above is discussed as being 400 Hz, it should be noted that the emission frequency may be any multiple of 100 Hz, such as 500 Hz, 600 Hz, and so on.

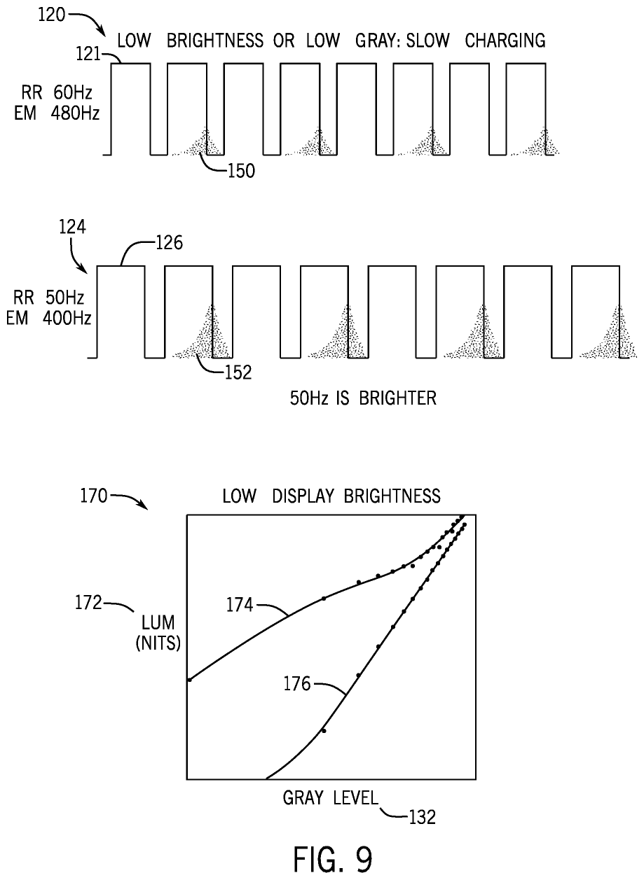

The graph 130 illustrates brightness outputs at higher brightness levels of display pixels 54 having a 60 Hz refresh rate (e.g., corresponding to the timing diagram 120) and display pixels 54 having a 50 Hz refresh rate (e.g., corresponding to the timing diagram 124). The graph 130 includes an x-axis 132 illustrating gray level, and a y-axis 134 illustrating brightness (in nits). The y-axis 134 may represent relatively higher brightness levels, such as ranging from 0.3 nits to 200 nits (e.g., on a logarithmic scale). The graph 130 includes a curve 136 representing brightness as a function of gray level for a display pixel 54 having a refresh rate of 50 Hz and a curve 138 representing brightness as a function of gray level for a display pixel 54 having a refresh rate of 60 Hz. As may be observed from the graph 130, the curve 136 illustrates slightly brighter display pixels 54 at lower gray levels, but the curve 136 and the curve 138 are similar at higher gray levels. Accordingly, at higher brightness levels, display pixels 54 having an emission frequency of 400 Hz (or an emission frequency of any multiple of 100, such as 500 Hz, 600 Hz, and so on) and a refresh rate of 50 Hz may have a FoS appearance similar to that of display pixels 54 having an emission frequency of 480 Hz and a refresh rate of 50 Hz. However, as will be discussed with respect to FIG. 9 below, the differences between display pixels 54 having a refresh rate of 50 Hz and display pixels 54 having a refresh rate of 60 Hz may diverge substantially at lower brightness.

FIG. 9 illustrates operation of a display pixel 54 under low-brightness (e.g., low-luminance) condition at various refresh rates. The timing diagram 120 illustrates a display pixel 54 having a 60 Hz refresh rate. At low brightness, a voltage 150 of the display pixel 54 (indicated by the shading in each of the pulses 121) may not reach a maximum amplitude for each of the pulses 121, indicating less than full charging—and thus less than full brightness—of the display pixel 54.

The timing diagram 124 illustrates a display pixel 54 having a 50 Hz refresh rate. As was previously stated, as the refresh rate of the timing diagram 124 is 50 Hz rather than 60 Hz (as show in the timing diagram 120), the pulses 126 may be 20% longer than the width of the pulses 121. Given the extended pulse width, the display pixels 54 may have more time to charge at each pulse 126 than at the pulses 121. In contrast to the high-brightness condition discussed with respect to FIG. 8 above, at lower brightness, the longer pulse-width of the 50 Hz pulses 126 may result in higher charging of the pulses 126 than the pulses 121, causing a brightness differential between display pixels 54 having a refresh rate of 60 Hz and display pixels 54 having a refresh rate of 50 Hz.

A graph 170 illustrates brightness outputs at lower brightness levels of display pixels 54 having a 60 Hz refresh rate (e.g., corresponding to the timing diagram 120) and display pixels 54 having a 50 Hz refresh rate (e.g., corresponding to the timing diagram 124). The graph 170 includes an x-axis 132 illustrating gray level, and a y-axis 172 illustrating brightness (in nits). The y-axis 172 may represent relatively lower brightness levels, such as ranging from 0.01 nits to 20 nits (e.g., on a logarithmic scale). The graph 170 includes a curve 174 representing brightness as a function of gray level for a display pixel 54 having a refresh rate of 50 Hz and a curve 176 representing brightness as a function of gray level for a display pixel 54 having a refresh rate of 60 Hz. As may be observed from the graph 170, the curve 174 illustrates significantly brighter display pixels 54 than the curve 176 at lower gray levels, which may cause FOS issues and negatively impact user experience. Accordingly, at lower brightness levels, display pixels 54 having an emission frequency of 400 Hz (e.g., or 500 Hz, 600 Hz, and so on) and a refresh rate of 50 Hz may have a FoS appearance that may be significantly dimmer than that of display pixels 54 having an emission frequency of 480 Hz and a refresh rate of 50 Hz. This brightness differential may be mitigated or eliminated by applying different a first driving scheme to the display pixels 54 having a 50 Hz refresh rate and a second driving scheme to the display pixels 54 having a 50 Hz refresh rate.

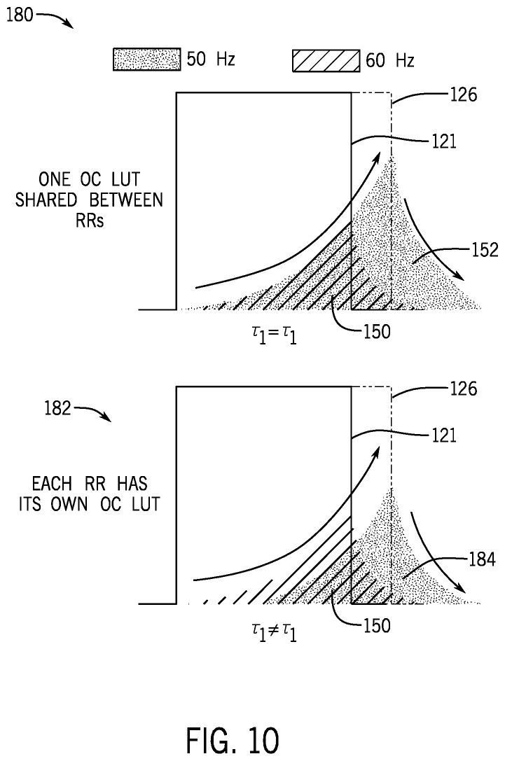

In some embodiments, an electronic display 12 having two different refresh rates may share a common OC LUT. For example, the electronic display 12 may have a refresh rate of 50 Hz at one time, but the refresh rate may be adjusted in settings to have a 60 Hz refresh rate at another time. In some embodiments, the electronic display 12 may share the same OC LUT under both refresh rate conditions. By sharing the same OC LUT, the electronic display 12 having a refresh rate of 60 Hz may receive the same gray level and voltage as the electronic display 12 having a refresh rate of 50 Hz. FIG. 10 includes a diagram 180 illustrating the charging of a display pixel with a 60 Hz refresh rate and the charging of a display pixel with a 50 Hz refresh rate when the display pixels shares an OC LUT under both the 50 Hz refresh rate and the 60 Hz refresh rate conditions. FIG. 10 includes a diagram 182 illustrating the charging of a display pixel 54 of the electronic display 12 with a 60 Hz refresh rate and the charging of a display pixel 54 of the electronic display 12 with a 50 Hz refresh rate when the electronic device has separate OC LUTs for the separate refresh rate conditions, according to an embodiment of the present disclosure. As previously discussed, and as may be observed from the diagram 180, the pulse width of the 50 Hz pulse 126 is wider than the pulse width of the 60 Hz pulse 121. Consequently, the display pixels 54 under the 50 Hz refresh rate condition have a longer period of time in which to charge than under the 60 Hz refresh rate condition, and thus the voltage 152 of the 50 Hz pulse 126 is greater than the voltage 150 of the 60 Hz pulse 121. Such a voltage differential associated with the 50 Hz pulse 126 and the 60 Hz pulse 121 may cause a noticeable brightness differential between the electronic display 12 under the respective conditions, which may cause noticeable FOS differences between images displayed under the 50 Hz refresh rate condition and the 60 Hz refresh rate condition, leading to negatively impacted user experience.

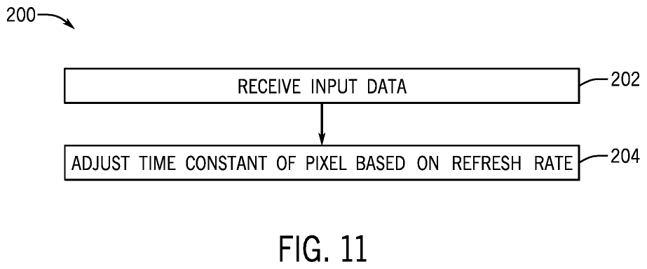

To eliminate or mitigate the brightness and/or color differential due to the difference in pulse widths between the 50 Hz pulse 126 and the 60 Hz pulse 121, a time constant of a resistor-capacitor (RC) circuit of the display pixels 54 may be adjusted. FIG. 11 is a flowchart of a method 200 for adjusting the time constant of one or more of the display pixels 54 to reduce or eliminate a brightness differential between at least two of the display pixels 54, in accordance with embodiments of the present disclosure. In process block 202, pixel circuitry or processing circuitry (e.g., the processor core complex 18) may receive input image data. In process block 204, the pixel circuitry or the processing circuitry may adjust a time constant of one or more of the display pixels 54 to reduce or increase the brightness and/or color of the one or more of the display pixels 54. The pixel circuitry or the processing circuitry may adjust the time constant by providing different gray levels to the pixels having a 50 Hz refresh rate and the pixels having a 60 Hz refresh rate. To provide different gray levels, multiple OC LUTs may be used, such that the 50 Hz refresh rate pixels correspond to a first OC LUT (which may provide a first gray level adjustment) and the 60 Hz refresh rate pixels correspond to a second OC LUT (which may provide a second gray level adjustment). By using multiple OC LUTs, various driving currents or driving voltages may be used for each of the display pixels to adjust the time constant.

For example, the pixel circuitry or the processing circuitry may reduce the gray level values sent to the display pixels 54 having a 50 Hz refresh rate or may increase the gray level values sent to the display pixels 54 having a 60 Hz refresh rate. By reducing the gray level values of the display pixels 54 having a 50 Hz refresh rate, the voltage of the 50 Hz pulse 126 may charge slower, reducing the overall charge of the 50 Hz pulse 126 and thus reducing the brightness of the 50 Hz pulse 126. Additionally or alternatively, by increasing the gray level values of the display pixels 54 having a 60 Hz refresh rate, the voltage of the 60 Hz pulse 121 may charge faster, increasing the overall charge of the 60 Hz pulse 121, and thus increasing the brightness of the 60 Hz pulse 121. By decreasing the overall charge associated with the 50 Hz pulse 126 and/or increasing the overall charge associated with the 60 Hz pulse 121, the brightness and/or color differential between the electronic display 12 under the 50 Hz refresh rate condition and the 60 Hz refresh rate condition may be reduced or eliminated.

Returning to FIG. 10, the diagram 182 illustrates the brightness differential between the 60 Hz pulse 121 and the 50 Hz pulse 126 after the time constant of the pixels having a 50 Hz refresh rate have been adjusted. As may be appreciated, the 50 Hz pixels and the 60 Hz pixels do not share a time constant in the diagram 182. The gray levels (e.g., and thus the driving current and/or the driving voltage) of the pixels having a 50 Hz refresh rate are reduced to provide a voltage 184 to the pixels having a 50 Hz refresh rate that is closer to the voltage 150 of the pixels having a 60 Hz refresh rate. In this manner, adjusting (via different OC LUTs) the time constant of the display pixels 54 in an electronic display under different conditions (e.g., applying a first time constant to the display pixels 54 across the electronic display 12 under a 50 Hz refresh rate condition and applying a second time constant to the display pixels 54 across the electronic display 12 under a 60 Hz condition) may reduce a brightness differential between the display pixels 54 operating at varying refresh rates.

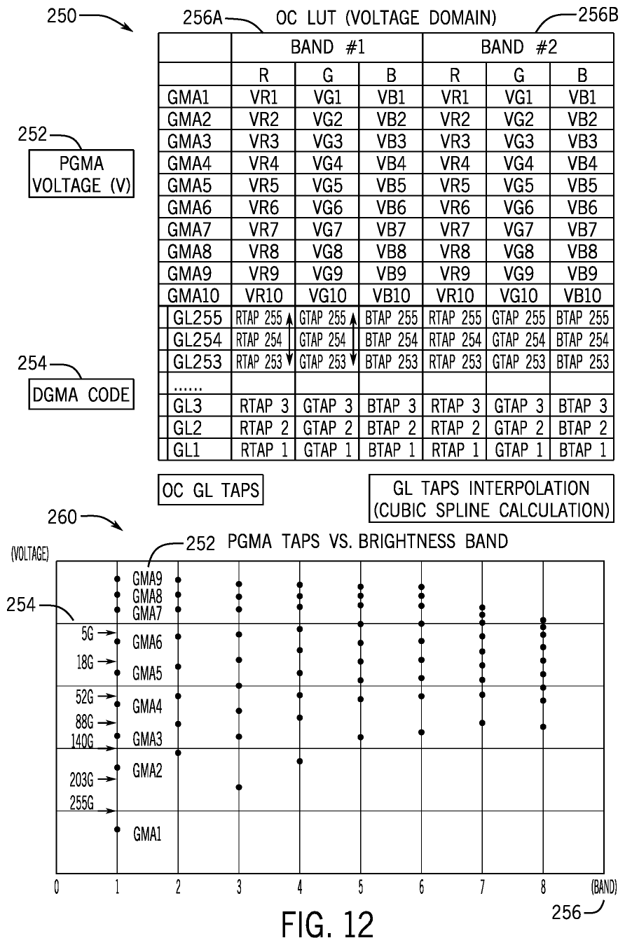

FIG. 12 includes an OC LUT 250 providing various pixel gamma (PGMA) voltages 252 and digital gamma (DGMA) codes 254 according to global display brightness (GDB) (e.g., display brightness value (DBV)) bands 256A and 256B (collectively, the GDB bands 256). A PGMA voltage 252 and a DGMA code 254 may be provided to each red (R), green (G), and blue (B) value of a display pixel 54 for each GDB band 256. The OC LUT 250 includes a list of voltages corresponding to RBG pixel color components and gamma values for each GDB band 256. For example, voltage VR1 is a voltage corresponding to a red pixel color component, VB1 is a voltage corresponding to a blue pixel color component, and VG1 is a voltage corresponding to a green pixel color component. Each of the voltages corresponding to the gamma levels GMA1-GMA10 may represent voltages associated a gamma voltage ladder. The OC LUT 250 includes tap points corresponding to the RGB color components and gray level values (e.g., GL 1-GL 255). The tap points may represent areas on the gamma voltage ladder that may be tapped to output a given gamma voltage.

FIG. 12 also includes a plot 260 illustrating PGMA voltages 252 and DGMA codes 254 across eight GDB bands 256. The OC LUT 250 may generate the DGMA codes 254 based on the PGMA voltages 252 and the GDB bands 256 and supply the DGMA codes 254 to the display pixels 54. As previously discussed, in some embodiments, the display pixels 54 of the electronic display 12 may share an OC LUT such as the OC LUT 250 under multiple refresh rate conditions, such as sharing a single OC LUT when operating at a 50 Hz refresh rate and a 60 Hz refresh rate. However, as previously discussed, in some instances sharing one OC LUT between multiple refresh rate conditions may result in significant (e.g., noticeable to the human eye) brightness differential. Consequently, it may be beneficial in some instances for the electronic display 12 to utilize different OC LUTs for respective refresh rate conditions.

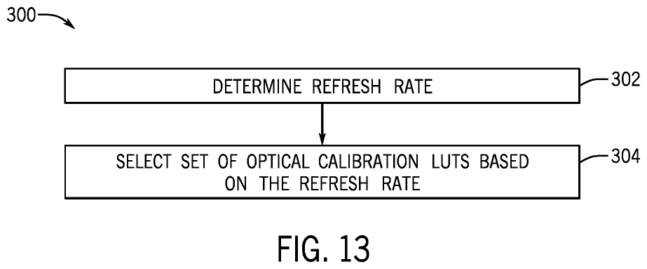

FIG. 13 is a flowchart of a method 300 for selecting a set of OC LUTs based on a determined refresh rate to reduce or eliminate a brightness differential between a display pixel 54 having a first refresh rate at a first time and a second display pixel 54 having a second refresh rate at a second time, in accordance with embodiments of the present disclosure. In process block 302, pixel circuitry or processing circuitry (e.g., the processor core complex 18) may determine refresh rate of a display pixel 54. The pixel circuitry or processing circuitry may determine whether the refresh rate is a divisor of a 480 Hz emission frequency (e.g., 60 Hz) or a non-divisor of a 480 Hz emission frequency (e.g., 50 Hz). In process block 304, the pixel circuitry or processing circuitry may select a set of optical calibration LUTs based on the determined refresh rate.

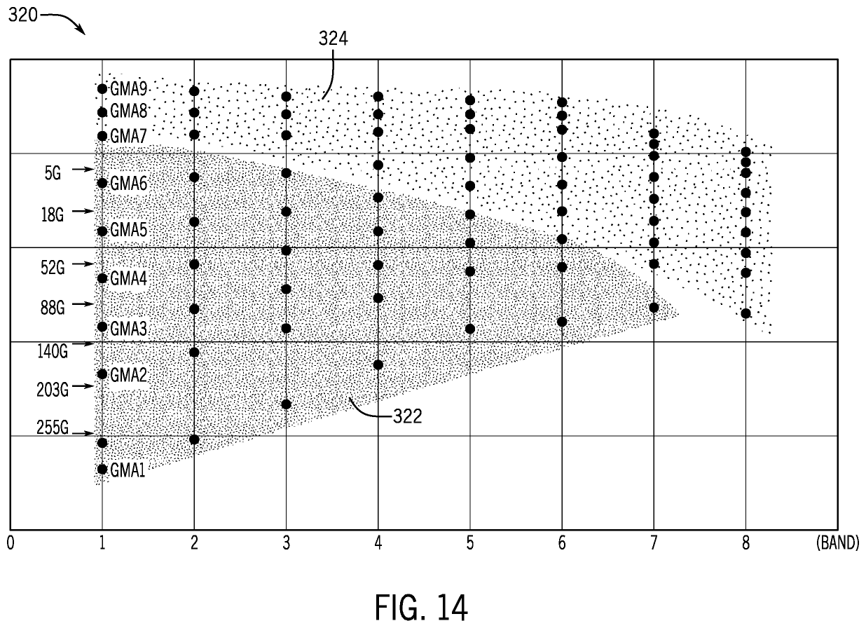

FIG. 14 is a plot 320 illustrating conditions under which display pixels 54 having different refresh rates (e.g., having a first refresh rate at time N and a second refresh rate at time N+1) may share a common OC LUT and conditions under which display pixels 54 may utilize separate OC LUTs, according to embodiments of the present disclosure. The plot 320 may be similar to the plot 260 discussed with respect to FIG. 12. The plot 320 may be divided into a section 322 and a section 324. The section 322 may include GDB values and gray level values in which the determined refresh rates (e.g., a 60 Hz refresh rate and a 50 Hz refresh rate) exhibit a brightness differential below a threshold. The threshold may include brightness differential or color differential.

For example, it may be determined in a design stage that input image data in a second GDB band at gray level 140G (e.g., in the section 322) causes 50 Hz display pixels and 60 Hz display pixels to exhibit a brightness differential less than 1% or a color differential less than 0.004, and consequently that the brightness of the 50 Hz display pixels and the 60 Hz display pixels are sufficiently similar in brightness or color to cause no FoS issues, and thus the display pixels 54 may operate off of the same OC LUT (e.g., the OC LUT 250) under 50 Hz refresh rates conditions and 60 Hz refresh rate conditions. That is, the display pixels 54 may receive the same DGMA codes 254 based on the PGMA voltages 252 and the GDB bands 256 under 50 Hz refresh rate conditions and 60 Hz refresh rate conditions.

However, in another example, it may be determined in a design stage that input image data in an eight GDB band at gray level 18G (e.g., in the section 324) causes display pixels 54 with a 50 Hz refresh rate and display pixels 54 with a 60 Hz refresh rate to exhibit a brightness differential greater than 1% or a color differential greater than 0.004, and consequently that the brightness of the 50 Hz display pixels and the 60 Hz display pixels are sufficiently different in brightness or color to cause FoS issues that may affect user experience. Consequently, under such conditions, the 50 Hz display pixels may receive GDB band and gray level relationships from a first OC LUT and the 60 Hz display pixels may receive GDB band and gray level relationships from a second OC LUT. That is, the 50 Hz display pixels and the 60 Hz display pixels may receive the different DGMA codes 254 based on the PGMA voltages 252 and the GDB bands 256. It should be noted that, while two OC LUTs are discussed, in some embodiments there may be a single OC LUT calibrated for a first refresh rate (e.g., 60 Hz) that may be adjusted for a second refresh rate (e.g., 50 Hz) by applying a unity gain to the OC LUT.

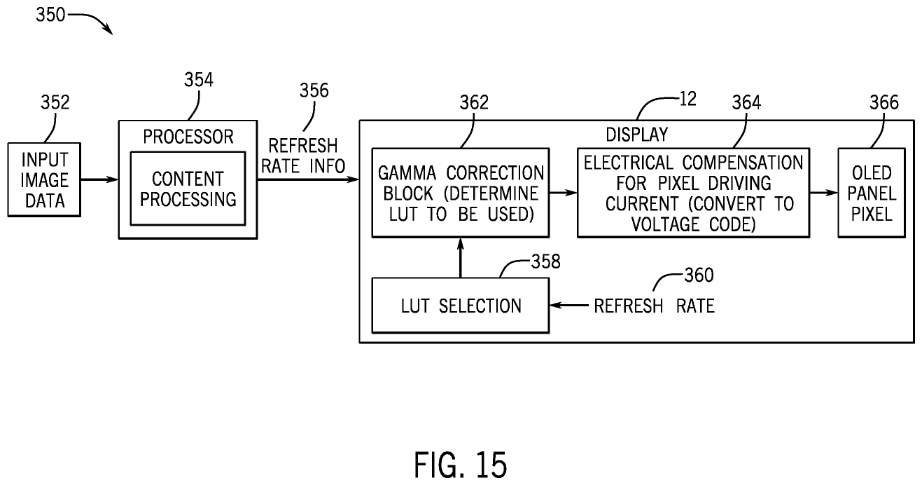

FIG. 15 is a block diagram illustrating the physical topology of the processes discussed above, according to embodiments of the present disclosure. The diagram 350 includes input image data 352, and a processor 354 (e.g., the processor core complex 18) configured to perform content (e.g., image) processing and send refresh rate info 356 to the display 12. In the display 12, LUT selection circuitry 358 may select an LUT based on a refresh rate 360 determined via the refresh rate info 356. For example, the LUT selection circuitry 358 may select one or more OC LUTs based on the refresh rate including a 50 Hz refresh rate and may select an additional one or more OC LUTs based on the refresh rate including a 60 Hz refresh rate. Gamma correction block 362 may receive the OC LUTs from the LUT selection circuitry 358 and choose which OC LUT to use based on GDB and gray level conditions as discussed with respect to FIG. 14. In electrical compensation circuitry 364 pixel driving current may be adjusted according to the OC LUT used and converted to a voltage code. The voltage code may be delivered to the display panel pixel 366 to cause the pixel driving circuitry of the display panel pixel 366 to generate the adjusted pixel driving current. In this manner, the diagram 350 may enable selection of an OC LUT based on refresh rate, which may be used to reduce or mitigate brightness differential between multiple display pixels 54.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic device, comprising:
an electronic display panel comprising a plurality of pixels; and
processing circuitry configured to:
process input image data having a target refresh rate; and
adjust a time constant of a pixel of the plurality of pixels based on the target refresh rate.

2. The electronic device of claim 1, wherein adjusting the time constant comprises adjusting a driving current of the pixel.

3. The electronic device of claim 1, wherein adjusting the time constant comprises adjusting a driving voltage of the pixel.

4. The electronic device of claim 1, wherein the pixel is configured to emit at an emission frequency comprising a multiple of 100 Hertz and configured to refresh at a refresh rate comprising a divisor of the emission frequency.

5. The electronic device of claim 4, wherein the refresh rate comprises 50 Hertz.

6. The electronic device of claim 4, wherein an additional pixel of the plurality of pixels is configured to emit at an additional emission frequency of 480 Hertz and configured to refresh at an additional refresh rate comprising a divisor of 480.

7. The electronic device of claim 6, wherein the additional refresh rate comprises 60 Hertz.

8. The electronic device of claim 6, wherein adjusting the time constant of the pixel comprises reducing the time constant of the pixel relative to an additional time constant of the additional pixel.

9. The electronic device of claim 8, wherein reducing the time constant of the pixel relative to the additional time constant of the additional pixel causes a brightness reduction of the pixel.

10. The electronic device of claim 6, wherein adjusting the time constant of the pixel comprises applying a first set of values corresponding to a first optical calibration lookup table (OC LUT) to the pixel and applying a second set of values corresponding to a second OC LUT to the additional pixel.

11. Tangible, non-transitory, computer-readable media comprising instructions that, when executed by one or more processors, cause the one or more processors to:
select a first set of values from a first lookup table (LUT) to generate a first voltage code for a first plurality of display pixels of an electronic display based on a first refresh rate associated with the first plurality of display pixels; and
select a second set of values from a second LUT to generate a second voltage code for a second plurality of display pixels of the electronic display based on a second refresh rate associated with the second plurality of display pixels.

12. The tangible, non-transitory, computer-readable media of claim 11, wherein the first set of values from the first LUT is different than the second set of values from the second LUT.

13. The tangible, non-transitory, computer-readable media of claim 11, wherein the first refresh rate comprises a 50 Hertz refresh rate.

14. The tangible, non-transitory, computer-readable media of claim 13, wherein the second refresh rate comprises a 60 Hertz refresh rate.

15. The tangible, non-transitory, computer-readable media of claim 11, wherein the first refresh rate comprises a refresh rate that is not a divisor of a 400 Hertz emission frequency, a 500 Hertz emission frequency, or a 600 Hertz emission frequency.

16. The tangible, non-transitory, computer-readable media of claim 15, wherein the second refresh rate comprises a refresh rate that is a divisor of a 480 Hertz emission frequency.

17. An electronic device, comprising:
processing circuitry configured to receive and process input image data and determine refresh rate information based on the input image data; and
an electronic display, comprising:
lookup table (LUT) selection circuitry configured to receive a refresh rate based on the refresh rate information and select one or more LUTs based on the refresh rate; and
gamma correction circuitry configured to use the one or more LUTs to generate voltage codes for a plurality of pixels.

18. The electronic device of claim 17, wherein the gamma correction circuitry is configured to select values from the one or more LUTs based on a first set of conditions associated with the input image data.

19. The electronic device of claim 18, wherein the first set of conditions comprises a plurality of gray level values.

20. The electronic device of claim 18, wherein the first set of conditions comprises a plurality of global display brightness values.
